(19) United States
(12) Patent Application Publication
(10) Pub. No.: US 2006/0279912 A1
(43) Pub. Date: Dec. 14, 2006

(54) Keyboard mounting apparatus for portable computer

(75) Inventors: Zheng Shi, Shenzhen (CN); Zhi-Gang Chen, Shenzhen (CN); Chien-Li Tsai, Tu-Cheng (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: HON HAI Precision Industry CO., LTD., Tu-Cheng City (TW)

(21) Appl. No.: 11/353,589

(22) Filed: Feb. 14, 2006

(30) Foreign Application Priority Data
Jun. 13, 2005 (CN) 200520060036.5

(51) Int. Cl. G06F 1/16

(52) U.S. Cl. 361/680

(57) ABSTRACT

A keyboard mounting apparatus includes a keyboard (30), a base housing (10), and a plurality of resilient tabs (40). The keyboard includes a plurality of first tips (32), and second tips (34) extending therefrom. The base housing includes a sunken socket (12) for accommodating the keyboard therein. A plurality of locking slots (16) is defined in a front wall (126) of the socket corresponding to the first tips of the keyboard. A plurality of cantilevers (14) each with a block (142) is formed in a rear wall (124) of the socket. A plurality of chambers (18) is defined in a bottom wall (122) of the socket for accommodating the resilient tabs. The first tips engage in the locking slots of the socket. The second tips engagingly with the blocks of the cantilevers. The resilient tabs engage with a bottom of the keyboard.

### BACKGROUND OF THE INVENTION

1. Field of the Invention

The present invention relates generally to keyboard devices, and more particularly to a mounting apparatus for easily installing and removing a keyboard in and from a portable computer.

2. General Background

Manufacturers of portable computers are striving to make them more durable and easier to use. In a conventional assembly method, screws are used to install a keyboard device to a portable computer. The screws are driven into a lower side of the portable computer, thereby fixing the keyboard device. The keyboard device is secure, but its installation or removal (such as for maintenance) is inconvenient.

Taiwan Patent Publication No. 348863 discloses a keyboard mounting apparatus for a portable computer. The mounting apparatus comprises a handle secured to opposite sides of a keyboard, and a button controlling the forward or rearward movement of a plate engaging with the handle. The forward or rearward movement of the plate set a locked or unlocked status of the keyboard in the portable computer. However, the button is disposed at a base housing of the portable computer. Because the portable computer is typically carried about and used at various locations, the button can be easily moved or released due to vibration, impact or inadvertant operation. Moreover, the handle occupies a relatively large space, and detracts from the aesthetic appearance of the portable computer.

For the above reasons, an improved keyboard mounting apparatus for a portable computer is desired.

### SUMMARY

In one preferred embodiment, a keyboard mounting apparatus includes a keyboard, a base housing, and a plurality of resilient tabs. The keyboard includes a plurality of first tips, and second tips extending therefrom. The base housing includes a sunken socket for accommodating the keyboard therein. A plurality of locking slots is defined in a front wall of the socket corresponding to the first tips of the keyboard. A plurality of cantilevers each with a block is formed in a rear wall of the socket. A plurality of chambers is defined in a bottom wall of the socket for accommodating the resilient tabs. The first tips engage in the locking slots of the socket. The second tips engagingly with the blocks of the cantilevers. The resilient tabs engage with a bottom of the keyboard.

Other advantages and novel features will become more apparent from the following detailed description when taken in conjunction with the accompanying drawings, in which:

### BRIEF DESCRIPTION OF THE DRAWINGS

FIG. 1 is an exploded, isometric view of a keyboard mounting apparatus for a portable computer in accordance with the preferred embodiment of the present invention;

FIG. 2 is an enlarged view of FIG. 1, being partially cut away;

FIG. 3 is an enlarged, isometric view of a base housing of the keyboard mounting apparatus of FIG. 1, but viewed from another aspect;

FIG. 4 is an enlarged, isometric view of a keyboard of the keyboard mounting apparatus of FIG. 1, but viewed from another aspect; and

FIG. 5 is an assembled view of FIG. 1, being partly cut away.

### DETAILED DESCRIPTION OF THE EMBODIMENT

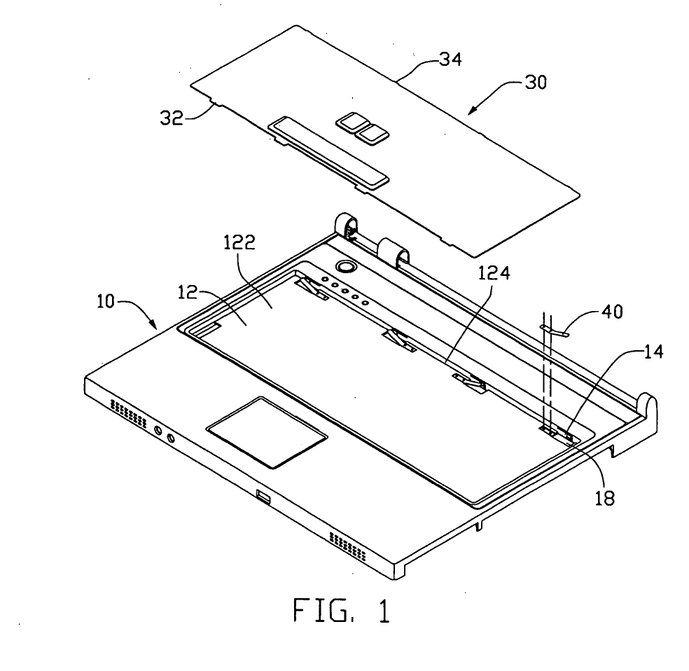

Referring to FIG. 1, a keyboard mounting apparatus in accordance with a preferred embodiment of the present invention includes a keyboard 30, a base housing 10 of a portable computer, and a plurality of resilient tabs 40.

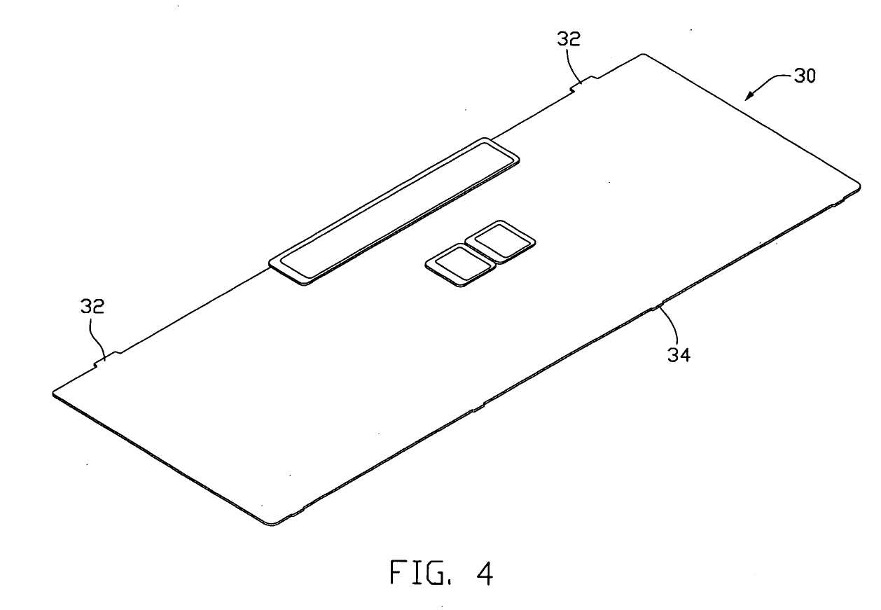

Referring also to FIG. 4, the keyboard 30 includes a plurality of aligned first tips 32 extends forwardly from a front end of the keyboard 30. The keyboard 30 includes a plurality of aligned second tips 34 extends rearwardly from a rear end of the keyboard 30.

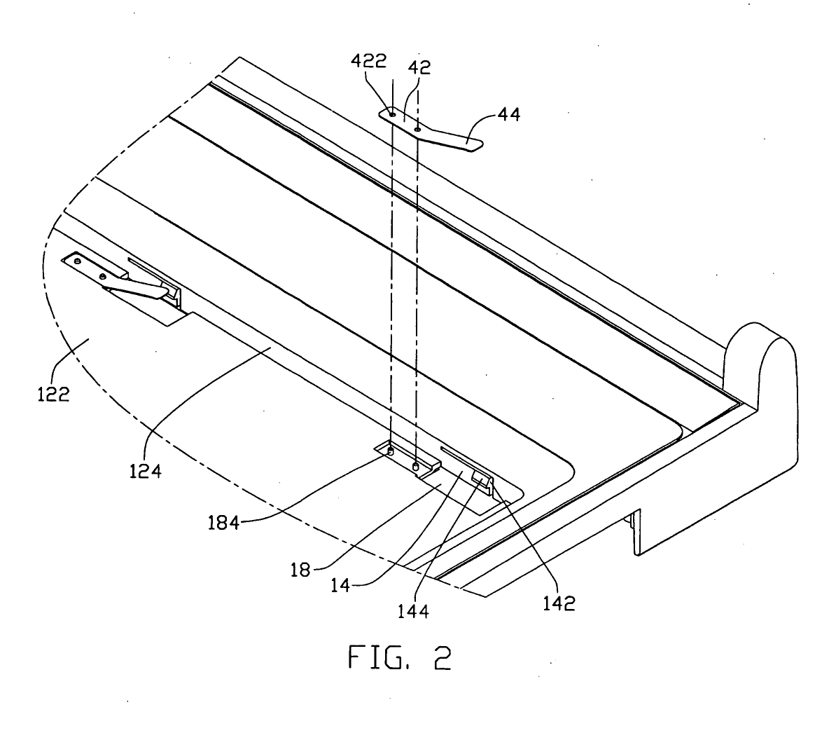

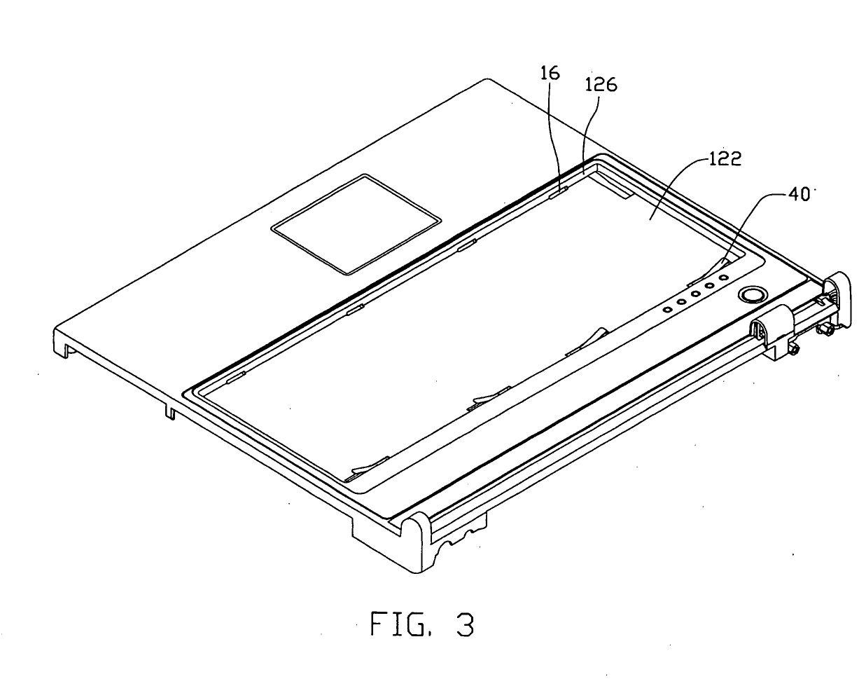

Referring also to FIGS. 2 and 3, the base housing 10 defines a sunken socket 12 for accommodating the keyboard 30 therein. The sunken socket 12 includes a bottom wall 122, a front wall 126, and a rear wall 124 so as to define a socket opening along a top surface of the base housing 10 opposite to the bottom wall 122. A plurality of aligned locking slots 16 is defined in the front wall 126 of the sunken socket 12, corresponding to the first tips 32 of the keyboard 30. A plurality of chambers 18 is defined in the bottom wall 122, for accommodating the resilient tabs 30 therein. Each of the chambers 18 includes a shallow portion, and a deep portion communicating the shallow portion. A pair of pins 184 is formed in the shallow portion of each of the chambers 18. A plurality of cantilevers 14 is formed in the rear wall 124 of the sunken socket 12, corresponding to the chambers 18. A block 142 extends from an end portion of each of the cantilevers 14, extending into the socket 12. Each of the blocks 142 includes a sloping surface 144.

Each of the resilient tabs 40 is made of elastic material such as plastic, and includes a main portion 42. A free portion 44 extends slantly and outwardly from one end of the main portion 42. A pair of through holes 422 is defined in the main portion 42.

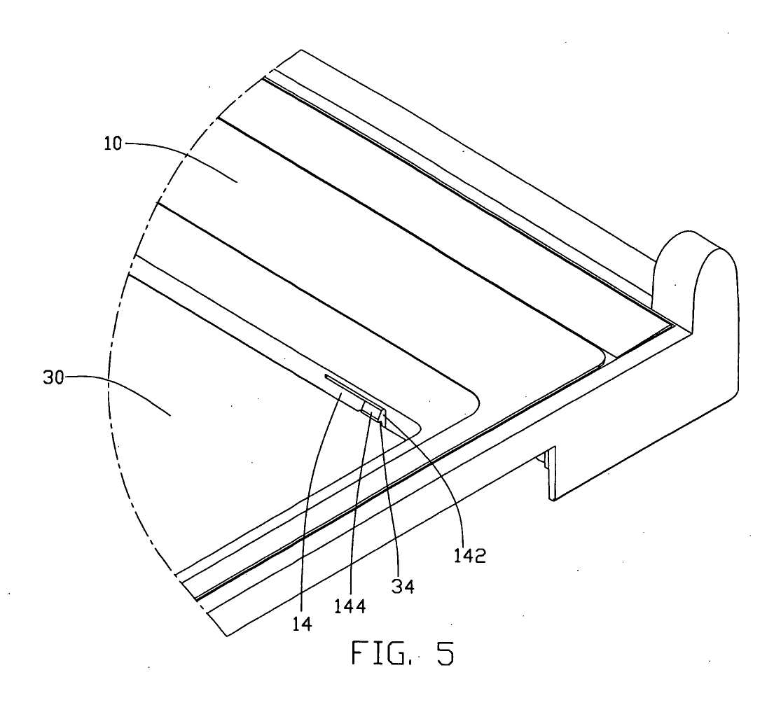

Referring also to FIG. 5, in assembly, the resilient tabs 40 are secured in the chambers 18 of the base housing 10, with the pins 184 engaging in the through holes 422. The first tips 32 of the keyboard 30 are inserted into the corresponding locking slots 16 of the sunken socket 12 of the base housing 10. The second tips 32 slide along the sloping surfaces 144 and abut the blocks 142 of the cantilever 14 to move the blocks 144 away the socket 12 until the second tips 34 are fully located below the blocks 144. The free portions 44 of the resilient tabs 40 are depressed by the keyboard 30. The keyboard 30 is secured in the socket 12 of the base housing 10.

To remove the keyboard 30 from the base housing 10, the cantilevers 14 are pushed away from socket 12 so that the second tips 34 disengage from the blocks 144 thereof. A side of the keyboard 30 with the second tips 34 is raised from the socket 12 when the resilient tabs 40 are rebound. Thus, the keyboard 30 is easily taken out from the base housing 10.

It is believed that the present embodiment and its advantages will be understood from the foregoing description, and it will be apparent that various changes may be made thereto without departing from the spirit and scope of the invention or sacrificing all of its material advantages, the example hereinbefore described merely being a preferred or exemplary embodiment of the invention.

What is claimed is:

1. A keyboard mounting apparatus comprising:
a base housing defining a socket, the socket comprising two opposite sidewalls, one of the sidewall defining a plurality of locking slots, and the other sidewall comprising a plurality of cantilevers each with a block; and
a keyboard received in the socket, the keyboard comprising a plurality of first tips engaging in the slots, and a plurality of second tips resiliently engaging with the blocks.

2. The keyboard mounting apparatus as claimed in claim 1, further comprising a plurality of resilient tabs, wherein the socket further comprises a bottom wall defining a plurality of chambers for receiving the resilient tabs.

3. The keyboard mounting apparatus as claimed in claim 2, wherein each of the chambers comprises a pair of pins, each of the resilient tabs comprises a main portion defining a pair of through holes for engaging with the pins.

4. The keyboard mounting apparatus as claimed in claim 3, wherein each of the resilient tabs further comprises a free portion extending slantly from an end of the correspond main portion, engaging with a bottom of the keyboard.

5. The keyboard mounting apparatus as claimed in claim 1, wherein the blocks extend from free ends of the cantilevers and extend into the socket.

6. The keyboard mounting apparatus as claimed in claim 5, wherein each of the blocks further comprises a sloping surface.

7. A keyboard mounting apparatus comprising:
a keyboard comprising at least one first tips, and at least one second tip extending therefrom; and
a base housing defining a socket to receive the keyboard therein, the socket comprising a pair of sidewalls, and a bottom wall, one sidewall defining at least one locking slot engaging with said first tip, the other sidewall forming at least one cantilever with a block extruding therefrom, the block resiliently engaging with said second tip.

8. The keyboard mounting apparatus as claimed in claim 7, wherein the bottom wall comprises at least one resilient tabs abutting against a bottom of the keyboard.

9. The keyboard mounting apparatus as claimed in claim 8, wherein the bottom wall of the base housing comprises at least one chamber to hold said resilient tab therein.

10. The keyboard mounting apparatus as claimed in claim 9, wherein said chamber comprises a pair of pins, said resilient tab comprises a main portion defining a pair of through holes for engaging with the pins.

11. The keyboard mounting apparatus as claimed in claim 10, wherein said resilient tab further comprises a free portion extending slantly from an end of the main portion to engage with the bottom of the keyboard.

12. The keyboard mounting apparatus as claimed in claim 8, wherein the block extends from a free end of said cantilever and extends into the socket.

13. The keyboard mounting apparatus as claimed in claim 8, wherein the block further comprises a sloping surface.

14. An electronic device comprising:
a base housing forming a socket from a side thereof so as to define a receiving space in said socket and a socket opening for spatially communicating said space with an outside of said base housing, at least one resilient tab forming in said space opposite to said socket opening; and
a keyboard receivable in said space of said socket through said socket opening so as to be installed to said electronic device and substantially flush with said side of said base housing by means of occupying said socket opening, said keyboard tending to move out of said socket through said socket opening due to urging of said at least one resilient tab when said keyboard is fully received in said space.

15. The electronic device as claimed in claim 14, wherein said socket comprises at least one cantilever with a block extruding therefrom into said space so as to be engagable with said keyboard to retain said keyboard in said space when said keyboard is fully received in said space.
